(19) United States
(12) Patent Application Publication
(10) Pub. No.: US 2026/0297290 A1
(43) Pub. Date: Oct. 1, 2026

(54) MATERIAL FOR ADDITIVE EXTRUSION-BASED COMPONENT PRODUCTION

(71) Applicant: CERATIZIT AUSTRIA GMBH, REUTTE (AT)

(72) Inventors: MANUEL WALCH, REUTTE (AT); PETER LECHLEITNER, REUTTE (AT); KEVIN FITTSCHEN, REUTTE (AT); STEFAN HÖFLER, REUTTE (AT)

(21) Appl. No.: 19/478,955

(22) PCT Filed: Apr. 17, 2024
(86) PCT No.: PCT/EP2024/060342

§ 371 Date: Oct. 27, 2025

(30) Foreign Application Priority Data
Apr. 27, 2023 (EP) 23170238.2

(51) Int. Cl. C08K 3/08; B29C 64/118; B29K 1/00; B29K 105/16; B29K 505/00; B29K 509/04; B33Y 70/10; C08B 1/00

(52) U.S. Cl. CPC C08K 3/08; B33Y 70/10; C08B 1/00; B29C 64/118; B29K 2001/08; B29K 2105/16; B29K 2505/00; B29K 2509/04; B29K 2995/007; B29K 2995/0077; C08K 2003/0843; C08K 2003/0856; C08K 2003/0862; C08K 2201/005

(57) ABSTRACT

Material for additive extrusion-based component production containing: a percent by volume of sinterable filler material, b percent by volume of thermoplastic cellulose and c percent by volume of additive material, wherein a is in the range from 20 to 70 and b is in the range from 75 to 30 and c=(100−a−b).

The present invention relates to a material for additive extrusion-based component production, to a use of a material for additive extrusion-based component production, to an additive extrusion-based production process and to a composition.

The filament disclosed in EP 3 167 101 A1 is said to be suitable for use in a 3D printing apparatus, wherein the filament comprises a metal and/or ceramic powder, a thermoplastic binder and additives.

The as yet unplasticized and already unwound region of the filament disclosed in EP 3 167 101 A1 is said to act as a force transmitter to extrude the plasticized region. The manipulation necessary therefor (conveying, squeezing, deflecting) and forces acting on the filament often result in breakage thereof in the cold region while the low thermal mechanical stability thereof results in a softening even just due to process and component waste heat. Both disadvantages (easy breakage in the cold region and low thermomechanical stability) lead to reduced and/or failed force transfer, thus disrupting continuous material flow.

The transferable force and thus the speed at which additive extrusion-based production of the components based on the filament disclosed in EP 3 167 101 A1 may be performed is accordingly low and the risk of defectively additively produced components is accordingly high.

It is an object of the present invention to provide a material for additive extrusion-based component production, a use of a material for additive extrusion-based component production, an additive extrusion-based production process and a composition which make it possible to achieve continuous, stable and also precise additive extrusion-based component production.

The object is achieved by the respective subject matter of claims 1, 10, 11 and 12.

The material for additive extrusion-based component production consists of: a percent by volume of sinterable filler material, b percent by volume of thermoplastic cellulose, and c percent by volume of one or more additives, wherein a is in the range from 20 to 70 and b is in the range from 75 to 30 and c=(100−a−b).

The sinterable filler material is bound by the thermoplastic cellulose, i.e. the thermoplastic cellulose acts as a binder. The sinterable filler material preferably consists of powder particles.

The material may be in the form of a product conveyable by a conveying mechanism, for example in the form of a filament, a sheet or a rod, or in the form of a starting material for such a product, for example in the form of a granulate; in contrast to a rod, the filament is windable onto a roll. However, the granulate may also be used in a and by a 3D printer for example fitted with a screw extruder as a conveying and plasticizing unit for additive extrusion-based component production.

Thermoplastic cellulose is to be understood as meaning a cellulose which exhibits substantially plastic behaviour upon entry into a temperature range, for example above 120° C., and exhibits substantially elastic behaviour before entry into this temperature range, for example at 20° C.

Preferred thermoplastic celluloses are: hydroxypropylcellulose, hydroxypropylmethylcellulose, hydroxyethylmethylcellulose and hydroxyethylcellulose. However, the present invention is not to be understood as being limited to these thermoplastic celluloses.

The thermoplastic cellulose has the effect that it imparts to a product produced from the material, for example the filament, the sheet or the rod, a high surface hardness and high stiffness coupled with high ductility and high thermomechanical stability.

The additive material may consist of a liquid or solid additive component or of a plurality of liquid or solid additive components or of a mixture of solid and liquid additive components, wherein the additive component or the plurality of additive components may in each case be at least in the form of a plasticizer, tackifier, lubricant or dispersant.

When the material is in the form of the product conveyable by a conveying mechanism, for example by rolls or cogs, the substantially as yet unplasticized and already conveyed region, for example in the case of the filament the unwound region, may act as a force transmitter on the substantially plasticized region to the effect extrusion thereof.

Due to the thermoplastic cellulose the material may be more strongly and/or more frequently manipulated in the substantially elastic state, for example more strongly squeezed and more frequently bent, the material also exhibiting more stable behaviour under the influence of process and component waste heat.

The material is more readily handleable and conveyable while at the same time exhibiting sufficient stiffness and surface hardness at room temperature to allow more reliable conveying by mechanical contact when it is in the form of a conveyable product, for example in the form of a rod, sheet or filament; the same applies when the material is in the form of a granulate and the conveyable product is produced therefrom. The substantially elastic region adjacent to a substantially plastic region of the material may be more readily pushed and pulled in the direction of a conveying motion.

The material may be used to produce a green body on the basis of additive extrusion. The green body may be subjected to thermal debinding, thus allowing the thermoplastic cellulose and the additive material to be substantially removed.

When the material consists of a percent by volume of sinterable filler material, b percent by volume of thermoplastic cellulose and c percent by volume of the additive material, wherein a is in the range from 20 to 70 and b is in the range from 75 to 30 and c=(100−a−b) the following especially applies: (a+b+c)=100, (a+b) ≤100, (a+c) ≤100, (c+b) ≤100, (when (a+b)=100, then c=0), (a>b or a<b or a=b).

When c=0 the material accordingly consists of the sinterable filler material and the thermoplastic cellulose.

The thermoplastic cellulose may consist of a thermoplastic cellulose component, for example hydroxypropylcellulose or of a plurality of thermoplastic cellulose components.

The sinterable filler material may consist of hard material particles embedded in a metallic matrix and the metallic matrix, wherein the hard material particles form the primary constituent of the sinterable filler material, i.e. at least 60 percent by weight or more of hard material particles based on the sinterable filler material, so that sintering causes the hard material particles to form a skeleton structure whose interspaces are fillable by the metallic matrix.

The sinterable filler material may alternatively consist of metal particles or metal alloy particles, wherein the metal of the metal particles or the metal alloy of the metal alloy particles form the primary constituent of the sinterable filler material, i.e. at least 60 percent by weight or more based on the sinterable filler material. The metal particles or metal alloy particles may optionally comprise embedded hard material particles, wherein, however, the metal of the metal particles or the metal alloy of the metal alloy particles continues to form the primary constituent of the sinterable filler material, i.e. at least 60 percent by weight or more of the metal or of the metal alloy based on the sinterable filler material.

The sinterable filler material may alternatively consist of ceramic particles.

In an advantageous development the material is in the form of a filament, i.e. it may be wound and unwound and in this form is continuously conveyable at least in sections. When the material is in the form of a filament it may be particularly readily conveyed by conveying rolls and compactly stored and provided by winding onto a spool (the filament is unwound from the spool during conveying), this manifesting the described advantages of the material particularly well.

In an advantageous development of the material the filament has a filament diameter in the range from 1 mm to 5 mm, preferably from 1.5 mm to 3 mm. At filament diameters greater than 5 mm the filament is more difficult to wind and unwind.

In an advantageous development of the material said material has a modulus of elasticity in the range from 200 N/mm² bis 2500 N/mm², preferably from 300 N/mm² to 2000 N/mm², at 23° C., wherein the modulus of elasticity is to be determined as a secant gradient in respect of the engineering strain values 0.01% and 0.05% of a stress-strain diagram attributed to the material.

The stress-strain diagram is to be determined according to ÖNORM ISO 527-1 (2019-12-01 edition).

Since the modulus of elasticity is to be determined as a secant gradient in the engineering strain range of 0.01% to 0.05% of a stress-strain diagram attributed to the material the determination of the modulus of elasticity thus differs from ÖNORM ISO 527-1 (2019-Dec.-1 edition). The secant gradient is thus to be calculated by Eₜ=(σ₂−σ₁)/(ε₂−ε₁), wherein Eₜ is the secant gradient, σ₁ is the stress to be reported in megapascals (MPa) at the engineering strain value ε₁=0.0001 (0.01 %) of the stress-strain diagram and σ₂ is the stress to be reported in megapascals (MPa) at the engineering strain value ε₂=0.0005(0.05 %) of the stress-strain diagram.

The stress-strain diagram is to be attributed to the material by extruding the material into five filament sections having a filament diameter of 2 mm to 3 mm and a length of 20 cm to 30 cm in a screw or piston extruder at a processing temperature between 140° C. and 180° C. and clamping the thus-extruded filament sections into respective tensile testing machines and performing on them respective tensile tests according to ÖNORM ISO 527-1 (2019-Dec.-1 edition) at a constant cross head speed of 1 mm/min until achievement of an engineering strain of 2%; the material is thus extruded to afford the filament sections to attribute the stress-strain diagram to the material as described even when it is already in the form of a filament.

The tensile tests may in each case employ a Zwick Z010 universal testing machine.

The maximum buckling force, exceedance of which causes the material to become unstable when it is in the form of a filament, rod or sheet, follows the modulus of elasticity attributed to the material in the range from 200 to 2500 N/mm², preferably from 300 to 2000 N/mm², at 23° C.; when the material is in the form of a granulate this relationship between the buckling force and the modulus of elasticity applies analogously to a product produced therefrom, i.e. to the filament, the rod and the sheet; i.e. when the magnitude of the modulus of elasticity increases the maximum buckling force increases and vice versa.

In an advantageous development of the material said material is attributed a Shore D hardness in the range from 40 to 95, preferably in the range from 49 to 90, at 23° C., wherein the Shore D hardness is to be measured on a hardness measurement test specimen produced from the material in additive extrusion-based fashion.

The Shore D hardness is to be measured according to ÖNORM ISO 868(2003-Sep.-1 edition) and the hardness measurement test specimen must accordingly meet the dimensional requirements under 5.1 and 5.2 of ÖNORM ISO 868(2003-Sep.-1 edition).

The hardness measurement test specimen is to be produced on the basis of additive extrusion by bringing the material into a substantially plastic state and applying it layerwise. In the additive extrusion-based production of the hardness measurement test specimen a person skilled in the art selects the process parameters such that the hardness measurement test specimen has balanced mechanical properties.

When the material is attributed a Shore D hardness of 40 to 95, preferably in the range from 49 to 90, at 23° C., the material, when in the form of a filament, sheet or rod, provides optimal resistance against force introduction by a conveying means, thus allowing it to be conveyed thereby in a dimensionally stable manner and allowing transmission of sufficient force without, for example, meshing teeth rubbing through the surface; the same applies when the material is in the form of a granulate and a product, for example the filament, the sheet or the rod, is formed therefrom.

In an advantageous development of the material the sinterable filler material is configured to form a sintered hard metal (cemented carbide), a sintered cermet, a sintered metal, a sintered metal alloy or a sintered ceramic.

When the sinterable filler material is configured to form a sintered hard metal or a sintered cermet the sinterable filler material forms during sintering a composite material in which hard material particles, which then form the predominant constituent of the composite material, form a skeleton structure whose interspaces are filled by a relatively more ductile metallic matrix. The hard material particles may especially be formed at least predominantly by tungsten carbide, titanium carbide and/or titanium carbonitride, wherein other hard material particles, especially carbides of elements of group IV to VI of the periodic table, may for example also be present in smaller amounts. The metallic matrix typically consists at least predominantly of cobalt, nickel, iron or a base alloy of at least one of these elements. However, other elements may also be dissolved in the metallic matrix in smaller amounts. A base alloy is to be understood as meaning that this element (the base element) forms the predominant constituent of the alloy. Most frequently employed is hard metal where the hard material particles are at least predominantly formed by tungsten carbide and the metallic matrix Is cobalt or a cobalt base alloy; the weight fraction of the corresponding tungsten carbide particles may especially be at least 60% by weight, preferably at least 70% by weight, yet more preferably at least 80% by weight and most preferably at least 90% by weight. In the context of the present disclosure skeleton structure is to be understood as meaning that the hard material particles, for example hard material particles formed substantially by tungsten carbide, form an uninterrupted particle network where any given hard material particle is in contact with at least one other hard material particle.

When the sinterable filler material is configured for forming the sintered metal or the sintered metal alloy, sintering of the sinterable filler material comprises sintering together metal particles, for example tungsten particles or molybdenum particles, or metal alloy particles, for example steel particles, wherein the metal of the metal particles or the metal alloy of the metal alloy particles form the primary constituent of the sinterable filler material, i.e. at least 60 percent by weight or more based on the sinterable filler material. The metal particles or metal alloy particles may optionally comprise embedded hard material particles, wherein, however, the metal of the metal particles or the metal alloy of the metal alloy particles continues to form the primary constituent of the sinterable filler material, i.e. at least 60 percent by weight or more of the metal or of the metal alloy based on the sinterable filler material.

The metal of the metal particles is to be understood as consisting of a metallic element, for example tungsten or molybdenum, the optional hard metal particles and unavoidable impurities, for example 99% by weight of the metallic element and 1% by weight of unavoidable impurities and the metal alloy of the metal alloy particles is to be understood as consisting of a mixture of a plurality of metallic elements, for example aluminium and copper, or of a mixture of at least one metallic element, for example iron, the optional hard material particles and a non-metallic element, for example carbon.

When the sinterable filler material is configured for forming a sintered ceramic, sintering of the sinterable filler maternal comprises sintering together ceramic particles, for example oxidic ceramic particles, for example aluminium oxide particles, or nitridic ceramic particles, for example silicon nitride particles.

In an advantageous development of the material the sinterable filler material is configured for forming the sintered cermet or the sintered hard metal in such a way that the sinterable filler material consists of hard material particles embedded in a metallic matrix having an average particle size in the range from 0.2 μm to 50 μm, preferably from 0.5 μm to 20 μm, and the metallic matrix, wherein the sinterable filler material is configured for forming the sintered metal or the sintered metal alloy in such a way that the filler material consists of metal particles or metal alloy particles having an average particle size in the range from 0.5 to 100 μm, preferably from 1 μm to 40 μm, wherein the sinterable filler material is configured for forming the sintered ceramic in such a way that the sinterable filler material consists of ceramic particles having an average particle size in the range from 0.1 μm to 100 μm, preferably from 0.5 μm to 50 μm.

The average particle size of the metal particles, metal alloy particles and the ceramic particles is in each case to be understood as meaning the particle size having a cumulative pass value of 50%, i.e. when 50% of the measured particle sizes in the collective are smaller and 50% are larger than the average particle size. A person skilled in the art selects a suitable method of measurement for measuring the average particle size, for example sieving for relatively large particles, laser diffraction with particles of medium size and gas absorption curves for relatively small particles.

The average particle size of the hard material particles is to be measured in the embedded state of the hard material particles, wherein the average particle size of the hard material particles is to be measured as the “linear intercept distance” according to international standard ISO 4499-2: 2008(E). EBSD images of polished sections of the metallic matrix and the hard material particles embedded therein are used as a measurement basis. The measurement methodology for such images is described for example in: K. P Mingard et al. ““Comparison of EBSD and conventional methods of grain size measurement of hard metals” Int. Journal of Refractory Metals & Hard Materials 27(2009 ) 213-223.

In an advantageous development the sinterable filler material consists of the hard material particles embedded in the metallic matrix and the metallic matrix, wherein the hard material particles are in the form of tungsten carbide particles, wherein the metallic matrix consists of cobalt, nickel or iron and unavoidable impurities or wherein the metallic matrix consists of a cobalt, nickel, iron, (cobalt+nickel), (cobalt+iron), (iron+nickel), (cobalt+iron+nickel) base alloy and unavoidable impurities.

In an advantageous development of the material the additive material is in the form of a plasticizer, tackifier, lubricant or dispersant.

The object is further achieved by the use of the material according to any of claims 1 to 9 for additive extrusion-based production of a component. The advantages described with respect to the material are realized analogously.

The object is also achieved by an additive extrusion-based production process comprising the steps of: providing the material according to any of claims 1 to 9, extrusion-based additive production of a component based on the provided material. The material is for example provided as a filament and substantially plasticized by heating, for example by heating to a temperature in the range from 190° C. to 220° C. (however a temperature outside this range is also conceivable and possible) and extruded onto a carrier in the thus-plasticized state.

The object is also achieved by a composition consisting of: a percent by volume of sinterable filler material, b percent by volume of thermoplastic cellulose and c percent by volume of additive material, wherein a is in the range from 20 to 70 and b is in the range from 75 to 30 and c=(100−a−b). This provides a composition which realizes the advantages described with respect to the material and on whose basis the material may be produced.

### EXEMPLARY EMBODIMENTS

Further advantages and useful properties of the invention are apparent from the description of exemplary embodiments which follows.

### Filament A

Material according to the invention was used to produce a filament A having a filament diameter of 1.78 mm.

The filament consists of a=49.3 percent by volume of sinterable filler material in the form of (cobalt and tungsten carbide), b=44.9 percent by volume of thermoplastic cellulose in the form of hydroxypropyl cellulose and c=5.8 percent by volume of additive material in the form of (polyethylene glycol 4000 and stearic acid). The hydroxypropylcellulose binds the sinterable filler material.

The sinterable filler material (cobalt and tungsten carbide) of filament A is pulverulent and consists of 8.2 percent by weight of cobalt in particulate form and 91.8 percent by weight of tungsten carbide in particulate form, in each case based on the sinterable filler material. The tungsten carbide particles are embedded in the cobalt particles which are larger than the tungsten carbide particles; i.e. the cobalt forms a metallic matrix having regard to the tungsten carbide hard material particles.

The tungsten carbide particles of filament A have an average particle size in the range from 0.5 μm to 0.8 μm; this range is typically described as “ultrafine”.

The additive material of filament A consists of 31 percent by volume of polyethylene glycol 4000 and 69 percent by volume of stearic acid, in each case based on the additive material.

Filament A is attributed a modulus of elasticity of 1710 N/mm² at 23° C., wherein the modulus of elasticity is determined as a secant gradient in respect of the engineering strain values 0.01% and 0.05% of a stress-strain diagram attributed to filament A; a further filament A*, analogous to filament A, but having a filament diameter of 2.89 mm was analogously attributed a modulus of elasticity of 1820 N/mm² at 23° C.

The stress-strain diagram was attributed to the filaments A and A* according to ÖNORM ISO 527-1 (2019-Dec.-1 edition) in such a way that the filament A or the filament A* was comminuted and extruded at a processing temperature between 140° C. in 180° C. in a screw or piston extruder to afford five filament sections having a filament diameter of 1.5 mm to 3 mm and a length of 20 cm to 30 cm and the thus-extruded filament sections were each clamped in a tensile testing machine (Zwick Z010) and subjected to respective tensile tests according to ÖNORM ISO 527-1 (2019-Dec.-1 edition) at a constant cross head speed of 1 mm/min until achievement of an engineering strain of 2%.

The secant gradient was determined using Eₜ=(σ₂−σ₁)/(ε₂−ε₁), wherein Eₜ is the secant gradient, σ₁ is the stress to be reported in megapascals (MPa) at the engineering strain value ε₁=0.0001 (0.01%) of the stress-strain diagram and σ₂ is the stress to be reported in megapascals (MPa) at the engineering strain value ε₂=0.0005(0.05%) of the stress-strain diagram.

Experiments with a 3D printer showed that filament A and filament A* are optimally stabilized with respect to buckling under compressive load so that a substantially elastic region (cold region) of filament A or filament A* transfers enough force to its substantially plastic region upon unwinding of the spool to push the plastic region out of a die.

A direct measurement of the buckling force of filament A and of filament A* In a Zwick Z010 tensile testing machine at a test speed of 5 mm/min and a clamped length of 100 mm of filament A or A* revealed that the modulus of elasticity determined as a secant gradient is proportional to the buckling force of the filament A or A*, more precisely F_{buckle}=((4*π²/L²)Eₜ*I), wherein F_{buckle} is the theoretical buckling force, L is the clamped length and I is the areal moment of inertia of the filament A; I=(π/4)*(d/2)⁴, wherein d is the filament diameter of filament A or A*.

Calculation of the modulus of elasticity from the measured buckling force or calculation of the buckling force from the measured modulus of elasticity Eₜ resulted in very good agreement between measured and calculated values. Filament A and filament A* exhibit approximately linear behaviour in each case under both tensile and compressive forces and at strain values in the range from 0.01% to 0.05% or from −0.01% to −0.05%. Bucking force thus correlates with modulus of elasticity. The higher the modulus of elasticity the higher too is the buckling force, which is in turn advantageous for use in 3D printing; the relationship was verified by further experiments on filaments produced from material according to the invention.

At 20° C. room temperature filament A and filament A* were in sections wound and unwound onto a spool having a diameter of 90 mm 10 times by hand without any breakage of the filament A or A*; analogous filaments without thermoplastic cellulose break more easily or already soften at lower temperatures or have a lower hardness.

Filament A is attributed a Shore D hardness of 77 at 23° C., wherein the Shore D hardness was measured on a hardness measurement test specimen produced from filament A on the basis of additive extrusion. The hardness measurement test specimen was produced on the basis of additive extrusion by bringing filament A into a substantially plastic state and applying it layerwise to a cuboid having dimensions of 20×50×4 mm. In the production of the hardness measurement test specimen the process parameters were selected such that the latter exhibits balanced mechanical properties.

Shore D hardness is to be measured according to the standard ÖNORM EN ISO 868(2003-Sep.-1 edition), the hardness measurement test specimen accordingly meeting the dimensional requirements under 5.1 and 5.2 of ÖNORM ISO 868(2003-Sep.-1 edition).

It has been found that the Shore D hardness of 77 and 23° C. better protects from rubbing-through of filament A in a conveying means.

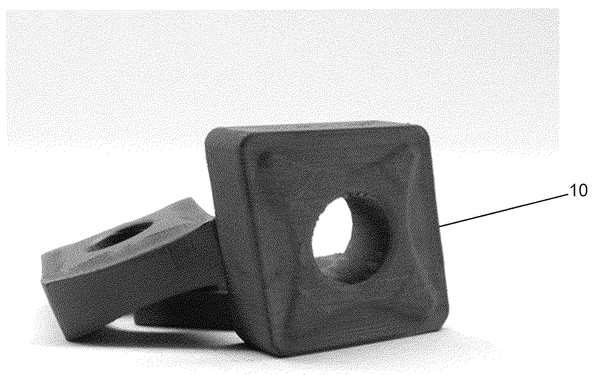

Filament A was used to produce the indexable insert green bodies shown in FIG. 1 in additive extrusion-based fashion.

### Filament B

Material according to the invention was used to produce a filament B having a filament diameter of 1.78 mm.

Filament B consists of a=60.0 percent by volume of sinterable filler material in the form of (stainless steel, type 1.4548 according to DIN EN 1088:2014-12, “X5CrNiCuNb”), b=34.0 percent by volume of thermoplastic cellulose in the form of hydroxypropylcellulose and c=6.0 percent by volume of additive material in the form of (polyethylene glycol 4000 and stearic acid). The hydroxypropylcellulose binds the sinterable filler material analogously to filament A.

The sinterable filler material (stainless steel, type 1.4548 according to DIN EN 10088:2014-2 “X5CrNiCuNb”) of filament B is pulverulent, i.e. is stainless steel powder of type 1.4548 according to DIN EN 10088:2014-12 (“X5CrNiCuNb”).

The stainless steel particles of filament B have an average particle size of 7.11 μm. The average particle size of the stainless steel particles of filament B was determined by laser diffraction.

The additive material (polyethylene glycol 4000 and stearic acid) or filament B consists of 23 percent by volume of polyethylene glycol 4000 and 77 percent by volume of stearic acid, in each case based on the additive material.

Filament B is attributed a modulus of elasticity of 1300 N/mm² at 23° C., wherein the modulus of elasticity is determined as a secant gradient in respect of the engineering strain values 0.01% and 0.05% of a stress-strain diagram attributed to filament B; the modulus of elasticity of filament B is determined analogously to the modulus of elasticity of filament A, i.e. filament B was comminuted and extruded for determination of the modulus of elasticity.

Analogously to filament A, filament B was partially wound and unwound onto a spool having a diameter of 90 mm 10 times by hand without any breakage of the filament B.

Filament B is attributed a Shore D Hardness of 68 at 23° C., wherein Shore D hardness was measured on a hardness measurement test specimen produced from filament B on the basis of additive extrusion; the hardness measurement test specimen was produced analogously to filament A.

### Further Filaments

Further filaments were produced analogously to filaments A and B, wherein in each case the volume fraction of the sinterable filler material and that of the thermoplastic cellulose were varied in the ranges a from 20 to 70 and b from 75 to 30, wherein the volume fraction of the additive material in each case conformed to c=(100−a−b). The filament diameter of the further filaments was also varied in the range from 1 mm to 5 m.

### Yet Further Filaments

Yet further filaments were produced from material according to the invention analogously to filament A, wherein the sinterable filter material of filament A was replaced by a ceramic (aluminium oxide) in powder form.

These further filaments too were able to be wound and unwound from a spool at least 10 times in each case without breakage and showed optimal force transfer of the respective substantially plastic region to the substantially plastic region during unwinding from the spool and optimal roll resistance.

Also produced were filaments made from material according to the invention wherein a variation of the additive material in type and proportion brought about other advantageous properties of the material according to the invention in terms of processing by additive manufacturing, for example improved layer adhesion, reduced printing bed adhesion, reduced viscosity in the melt etc.

1-12. (canceled)

13. A material for additive extrusion-based component production, the material consisting of:
a percent by volume of a sinterable filler material, b percent by volume of a thermoplastic cellulose and c percent by volume of an additive material, wherein a is in a range from 20 to 70 and b is in a range from 75 to 30 and c=(100−a−b).

14. The material according to claim 13, wherein the material is in a form of a filament.

15. The material according to claim 14, wherein said filament has a filament diameter in a range from 1 mm to 5 mm.

16. The material according to claim 13, wherein the material has a modulus of elasticity in a range from 200 to 2,500 N/mm² at 23° C., wherein the modulus of elasticity is determined as a secant gradient in respect of engineering strain values 0.01% and 0.05% of a stress-strain diagram attributed to the material.

17. The material according to claim 13, wherein the material has a Shore D hardness in a range from 40 to 95, at 23° C., wherein the Shore D hardness is to be measured on a hardness measurement test specimen produced from the material on a basis of additive extrusion.

18. The material according to claim 13, wherein said sinterable filler material is configured for forming a sintered hard metal, a cemented carbide, a sintered cermet, a sintered metal, a sintered metal alloy or a sintered ceramic.

19. The material according to claim 18, wherein:
said sinterable filler material is configured for forming said sintered cermet or said sintered hard metal such that said sinterable filler material has hard material particles embedded in a metallic matrix having an average particle size in a range from 0.2 μm to 50 μm, and of said metallic matrix;
said sinterable filler material is configured for forming said sintered metal or said sintered metal alloy such that said sinterable filler material consists of metal particles or metal alloy particles having an average particle size in the range from 0.5 to 100 μm; and
said sinterable filler material is configured for forming said sintered ceramic such that said sinterable filler material consists of ceramic particles having an average particle size in a range from 0.1 μm to 100 μm.

20. The material according to claim 19, wherein said sinterable filler material is formed of said hard material particles embedded in said metallic matrix and of said metallic matrix, wherein said hard material particles are in a form of tungsten carbide particles, wherein said metallic matrix contains cobalt, nickel or iron and unavoidable impurities or wherein said metal matrix contains cobalt, nickel, iron, cobalt+nickel base alloy, cobalt+iron base alloy, iron+nickel base alloy, or cobalt+iron+nickel base alloy and unavoidable impurities.

21. The material according to claim 13, wherein said additive material is in a form of a plasticizer, tackifier, lubricant or dispersant.

22. The material according to claim 17, wherein the material has the Shore D hardness in a range from 49 to 90.

23. The material according to claim 19, wherein:
said hard material particles embedded in said metallic matrix have an average particle size in a range from 0.5 μm to 20 μm;
said metal particles of said metal alloy particles have an average particle size in a range from 1 μm to 40 μm; and
said ceramic particles have an average particle size in a range from 0.5 μm to 50 μm.

24. A production method, which comprises the steps of:
providing the material according to claim 13; and
using the material in an additive extrusion-based production of a component.

25. An additive extrusion-based production process, which comprises the steps of:
providing the material according to claim 13; and
performing an additive extrusion-based production of a component on a basis of the material.

26. A composition, consisting of:
a percent by volume of a sinterable filler material;
b percent by volume of a thermoplastic cellulose; and
c percent by volume of an additive material, wherein a is in a range from 20 to 70 and b is in a range from 75 to 30 and c=(100−a−b).
